(19) United States
(12) Patent Application Publication
(10) Pub. No.: US 2021/0115891 A1
(43) Pub. Date: Apr. 22, 2021

(54) TURBINE AND METHOD FOR THE ROTATION THEREOF

(71) Applicants: Vladlen Anatoliiovych SNISAR, Zaporizhzhia (UA); Maksym Anatoliiovych SNISAR, Feodosiia (UA)

(72) Inventors: Vladlen Anatoliiovych SNISAR, Zaporizhzhia (UA); Maksym Anatoliiovych SNISAR, Feodosiia (UA)

(21) Appl. No.: 16/636,676

(22) PCT Filed: Aug. 3, 2018
(86) PCT No.: PCT/UA2018/000087

§ 371 Date: Feb. 5, 2020

(30) Foreign Application Priority Data
Aug. 7, 2017 (UA) A 2017 08146

(51) Int. Cl. F03B 17/06; F03B 3/12

(52) U.S. Cl. CPC F03B 17/061; F03D 1/0608; F03B 3/12

(57) ABSTRACT

The present turbine is intended for use in the field of renewable energy. The turbine comprises a rotor with a guide apparatus disposed thereon, said guide apparatus having inlets for a working fluid which are in the form of ducts that spiral around each other in helices and have nozzles situated along a tangent to the circle of rotation. The guide apparatus is configured in the form of adjacent ducts which are open along their entire length or along at least a significant portion of their length and are situated on second order surfaces of revolution or on portions of such surfaces, and in particular on convex-concave surfaces of the pseudosphere type with a cone in the pole of an axial cowl of the rotor. The result is in simplification of the structure and reduction in the turbine mass, the gyroscopic effect and the starting speed of the working fluid.

### CROSS-REFERENCE TO RELATED APPLICATIONS

This international patent application is a National stage application from PCT application PCT/UA2018/000087 filed Aug. 3, 2018 which claims priority to Ukrainian patent application A 201708146 filed Aug. 7, 2017.

### FIELD OF INVENTION

The invention relates to the renewable energy sector, namely hydraulic and wind energy systems, mobile energy systems, and low/medium power energy systems including rapid response systems.

### BACKGROUND

The closest prior art to the claimed turbine is the turbine of V. Schauberger home energy unit consisting of a rotor with a guide apparatus disposed thereon, said guide apparatus having inlets for a working fluid which are in the form of closed ducts made of pipes spiraling each other in helices, with nozzles situated along a tangent to the circle of their rotation or close to the tangent. (Internet publication: “A Home Generator” by Viktor Schauberger.) URL: http://khd2.narod.ru/shau/hps.htm (found in Internet Feb. 17, 2016).

The disadvantageous feature of this turbine is limitation of its use only to one aggregative state of working fluid, namely water. Also, it has a complex and heavy structure. Moreover, in this turbine, it is impossible to divide continuous flow of a hydroelectric power plant (HPP), course of a fast-flowing river, of a waterfall, of tidal and other sea streams, of the down water service, etc. into multiple helical flows.

Also, a method for a turbine rotation in a Segner wheel with reaction force is known. According to this principle, working fluid (water) is delivered to a vertical inlet pipe and moves from it to an impeller consisting of X-shaped pipes with bent ends (nozzles) located along a tangent to a circle of rotation. The reactive force of streams rotates the impeller. (Ryzhkov K. V. 100 Great Inventions.—M: Veche, 1999.—No. 53, Hydro turbine.)

In this method, the flow energy is wasted when working fluid suddenly changes its direction towards the nozzles. Moreover, this method doesn't allow to divide continuous flow into multiple individual flows.

The closest art of the claimed method for turbine rotation is the following: working fluid (water) is distributed into several flows and direct them along the helical paths spiraling each other into the nozzles situated along a tangent to the circle of rotation thereof or close to a tangent. Reactive force of the streams leaving the nozzles rotates the turbine impeller on which the nozzles are placed (Internet publication: “A Home Generator” by Viktor Schauberger.) URL: http://khd2.narod.ru/shau/hps.htm (found in Internet Feb. 17, 2016).

This method is effective because working fluid moves along the helical paths. It ensures laminar flow of working fluid but only one of its aggregative state, namely water. Moreover, in this method, it is impossible to divide continuous flow of a HPP, course of a fast-flowing river, of a waterfall, of tidal and other sea streams, of the down water service etc. into multiple helical flows.

### SUMMARY OF THE INVENTION

The main task of the first invention in the group is to improve the turbine in which by changing the structure of working fluid inlets and of the guide apparatus it was possible to ensure significant simplification of the structure, significant reducing of weight and, as a result, minimization of gyroscopic effect and initial speed of working fluid. It will allow to modify the turbines for different aggregative state of working fluid, flying wind turbines, mobile energy systems and rapid response systems, and to extend their application areas.

The main task of the second invention in the group is to improve the method for the turbine rotation. By changing the conditions of the working fluid inlet and moving working fluid inside the turbine it is possible to inlet and divide continuous flows of working fluid in various aggregative states.

The solution of the first task is as follows: in the turbine containing a rotor with a guide apparatus holding the working fluid inlet in the form of ducts that spiral around each other in helices or similar way, with nozzles situated along a tangent to the circle of rotation or close to the tangent, according to the invention, it is new that the guide apparatus is designed in the form of adjacent ducts that are open along the whole length or at least a considerable length and are situated on the second order surfaces of revolution, or on portions of such surfaces, or on combinations of these portions, in particular on convex-concave surfaces of the pseudosphere type with a cone in the pole of an axial cowl of the rotor.

Also the new is that the ducts of the guide apparatus have the form of smooth function spirals such as a logarithmic spiral with increasing pitch, an Archimedes spiral with constant pitch, a Fermat spiral with pitch reducing in the projection on a plane, or a loxodromic curve.

Also the new is that the ducts of the guide apparatus have form of spirals with quasismooth function and arranged along the paths gradually approaching the nozzle angle or close to it.

Also the new is that the ducts of the guide apparatus are formed on the axial cowl with ribbons or ribbon-like elements running parallel to the axis of rotation.

Also the new is that the ribbons have such elasticity and are connected in the nozzle area to the surface of revolution at such an arc size that, should the specified angular velocity of the turbine be exceeded, the ribbons can be slightly straightened under the influence of centrifugal forces to change the nozzle cross-section.

Also the new is that the ducts of the guide apparatus are formed with the ribbons or ribbon-like elements such as chutes, in the shape of helicoidal surface.

Also the new is that the helicoidal surfaces are bordered with shell rings.

Also the new is that the helicoidal surfaces are designed in the form of contours of the Yin-Yang Monad in a projection on a plane.

Also the new is that the helicoidal surfaces are designed as more than two-way ones in the form of quasicontours of the Yin-Yang Monad in a projection on a plane.

Also the new is that the axial cowl is inflatable.

Also the new is that the axial cowl is designed in the form of a tethered aerostat, mostly drop-shaped and quasispheroidal with a cone in the pole, and the nozzles are situated in the diameter zone of the maximum cross-section.

Also the new is that the tethered aerostat is designed with an inflatable shell ring with the ducts inside.

Also the new is that the tethered aerostat is designed with an inflatable shell ring with the ducts both inside and outside.

Also the new is that the turbine is designed with a dome in the form of a round parachute with its shrouds connected to the shaft, in particular telescopic one, as well as to the additional shrouds fixed to the dome in a zone of the nozzle circle and are wrapped with flexible material as an axial cowl.

Also the new is that the axial cowl is designed as a top part of the dome turned out inside, towards the nozzles.

Also the new is that the turned out part of the dome is closed and inflatable.

Also the new is that the dome, at least before its' intersection with the axial cowl, is multi-walled, at least two-walled, and is multi-ducted with inlets in its face part and bypass holes in its rear part, designed with such parameters that ensure maintaining the specified dome shape with velocity pressure of working fluid at minimal operating speed.

Also the new is that the turbine is designed with a dome in the form of an umbrella, in particular with a telescopic shaft, while guy lines are wrapped with flexible material as an axial cowl and the spokes are connected to the shaft with shrouds on the periphery.

Also the new is that the axial cowl is designed in the form of a tethered aerostat penetrating the dome.

Also the new is that the tethered aerostat contains devices heating buoyant gas.

Also the new is that the tethered aerostat is connected to a kite which is in particular has a structure of a paraplane with a multi-ducted dome or a with an airplane wing profile.

Also the new is that the dome ducts, at least part of them, are closed and inflatable.

Also the new is that inside the inflatable elements, there are inflatable balls of appropriate shape made of elastic gas-barrier material. These balls can be inflated to fill the cavities of the inflatable elements.

Also the new is that the inflatable elements are filled with buoyant gas that has density less than air density.

Also the new is that duct inlets on the axial cowl are located slightly lower its pole, the duct helices being slightly cut inside circle-wise.

Also the new is that the turbine has such a number of nozzles and such parameters that, at the rated speed of working fluid, the total capacity of the nozzles approaches that of the working fluid inlets.

Also the new is that the duct helices have such parameters that ensure, at the rated speed of working fluid, movement of working fluid along a motionless plane running through the axis of rotation of the turbine.

Also the new is that the outside turbine surface is coated, at least partially, with photovoltaic elements, particularly thin-film ones.

The following causal relationship exists between the set of essential features of the claimed device and the technical result that can be achieved.

The turbine consisting of the guide apparatus in the form of open ducts on the second order surfaces of revolution, in particular on the axial cowl, ensure laminar flow of working fluid inside the ducts of the guide apparatus and consistent joining of the additional working fluid masses, general simplification of the structure, reducing of weight, low initial speed of the working fluid, inletting and dividing continuous flows of the working fluid in various aggregative states, in particular continuous flow of large an small rivers, waterfalls, tidal and other sea streams, down water service etc.

The wind turbine design in the form of a parachute and an umbrella allows both batch and single-unit production of the turbines, in particular by the amateurs, to use the turbines as both fixed and mobile energy systems and rapid response systems in distressed areas, field camps, out settlements with poor infrastructure, various expeditions etc.

The turbine design with the guide apparatus ducts in the form of loxodromic and quasiloxodromic curves ensures maximum speed of working fluid inside the guide apparatus ducts.

The turbine design with the guide apparatus ducts in the form of Yin-Yang Monad, helices with increasing pitch, or with constant pitch, or with decreasing pitch allows to make turbines supporting various aggregative state and various rated speeds of working fluid.

The turbine design with an inflatable axial cowl in the form of an inflatable pseudosphere as a tethered aerostat and in the form of a tethered aerostat penetrating the dome of a parachute and of an umbrella allows to create an aerostatical turbine that doesn't need any towers and can work at altitudes where wind has constant direction and intensity. A device heating buoyant gas inside an aerostat and connection of an aerostat to a kite having form of a paraplane or of an airplane wing profile allow to keep an aerostat at the given altitude even in case of significant loss of buoyant gas from the aerostat or if wind changes its direction.

The inflatable balls located inside the inflatable elements allow to make the sheathes of the inflatable elements from the best heavy-duty materials, in particular ready for deserts, Arctic and Antarctic regions, away at sea and under other extreme conditions.

Given the expansion of production of electric cars, the wind turbines having simple structure, mostly in the form of tethered aerostats, parachutes and umbrellas, can be placed along the highways.

By changing the radius of nozzles circle and keeping other parameters unchanged, you can get various angular speed of the turbine, in particular with tangential speed of a periphery which significantly exceeds speed of working fluid flow.

The second task is solved thanks to the method for the turbine rotation, according to which working fluid is divided into several flows and is directed, along the helical or similar paths spiraling each other, into the nozzles located along tangent to circle of their rotation or close to it, according the invention, the new is that continuous flow of working fluid is divided into adjacent ducts which are open over the whole length or at least a considerable length.

Also the new is that the flows are directed along the paths having the shape of smooth function spirals such as a logarithmic spiral with increasing pitch, an Archimedes spiral with constant pitch, a Fermat spiral with pitch reducing in the projection on a plane, or a loxodromic curve.

Also the new is that the flows are directed along the paths having shape of spirals with quasismooth function and arranged along the paths gradually approaching the nozzles angle or close to it.

The following causal relationship exists between the set of essential features of the claimed method and the technical result that can be achieved.

When working fluid moves along the helical path, “friction reduces when speed increases, and after exceeding the critical speed, it moves with negative resistance; in other words, it is dragged into the duct and accelerated in it.” (Potapov Yu. S., Fominsky L. P. Energy of Rotation, Chapter 6.4, Hypothesis of Counterflow in a Vortex.) Directing of working fluid along loxodromic and quasiloxodromic curves helps to move working fluid from the beginning of path to the nozzles the fastest way possible. Directing of working fluid along other various helical paths allows to embody this method with various aggregative states and various rated speed of working fluid. Directing of working fluid for full or at least partial length of the path is functionally similar to consistent joining additional masses, “in ejection process of joining additional masses . . . draft increases without increasing energy input” (Kondrashov B. Brand New Jet Energy Technologies I/News of the Academy of Industrial Ecology.—2005.—No. 1.—P. 38.)

All these factors combine to increase the kinetic energy of the flows, i.e. efficiency and angular speed.

### BRIEF DESCRIPTION OF THE DRAWINGS

The concept of the invention is explained with the drawings containing the following:

FIG. 1—the wind turbine with the cone axial cowl;

FIG. 2—view A in FIG. 1;

FIG. 3—the hydro turbine with the axial cowl in the form of pseudosphere;

FIG. 4—view A in FIG. 3;

FIG. 5—the hydro turbine with the axial cowl in the form of oblate ellipsoid;

FIG. 6—view A in FIG. 5;

FIG. 7—the wind turbine in the form of Yin-Yang Monad;

FIG. 8—view A in FIG. 7;

FIG. 9—section B-B in FIG. 8;

FIG. 10—the hydro turbine in the form of quasicontours of Yin-Yang Monad;

FIG. 11—view A in FIG. 10;

FIG. 12—the wind turbine with the inflatable axial cowl, in particular in the form of a tethered aerostat;

FIG. 13—view A in FIG. 12;

FIG. 14—the wind turbine with the axial cowl—the tethered aerostat with the kite-paraplane;

FIG. 15—view A in FIG. 14;

FIG. 16—the detail I in FIG. 14;

FIG. 17—the wind turbine in the form of a tethered aerostat with the shell ring and the kite;

FIG. 18—view A in FIG. 17;

FIG. 19—the wind turbine-parachute with the turned out part of the dome as the axial cowl;

FIG. 20—view A in FIG. 19;

FIG. 21—the detail I in FIG. 19;

FIG. 22—the detail II in FIG. 20;

FIG. 23—the wind turbine-umbrella;

FIG. 24—view A in FIG. 23;

FIG. 25—section A-A at the FIG. 24;

FIG. 26—the detail I in FIG. 23;

FIG. 27—the detail II in FIG. 23;

FIG. 28—the detail III in FIG. 23;

FIG. 29—the wind turbine-umbrella penetrated with the tethered aerostat;

FIG. 30—view A in FIG. 29;

FIG. 31—section A-A at the FIG. 30;

FIG. 32—the detail I in FIG. 29;

FIG. 33—the detail II in FIG. 29.

The dotted arrows indicate direction of working fluid, the curved arrow indicates direction of the turbine rotation.

All the drawings are made as technical sketches.

### PREFERRED EMBODIMENT OF THE INVENTION

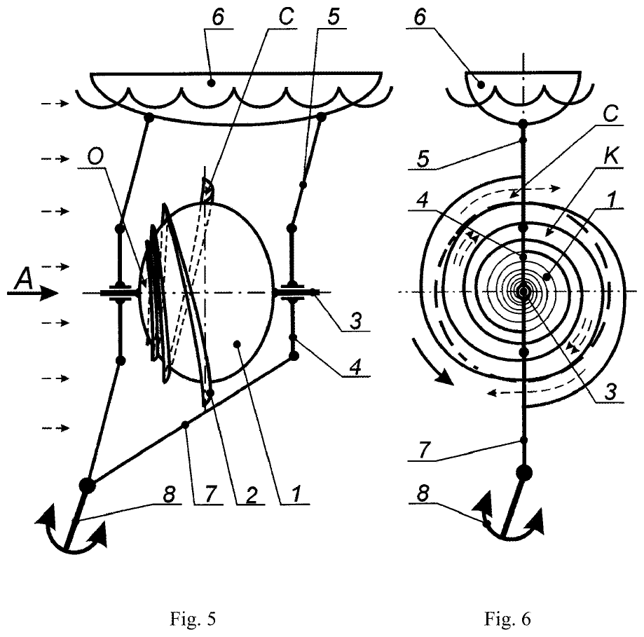

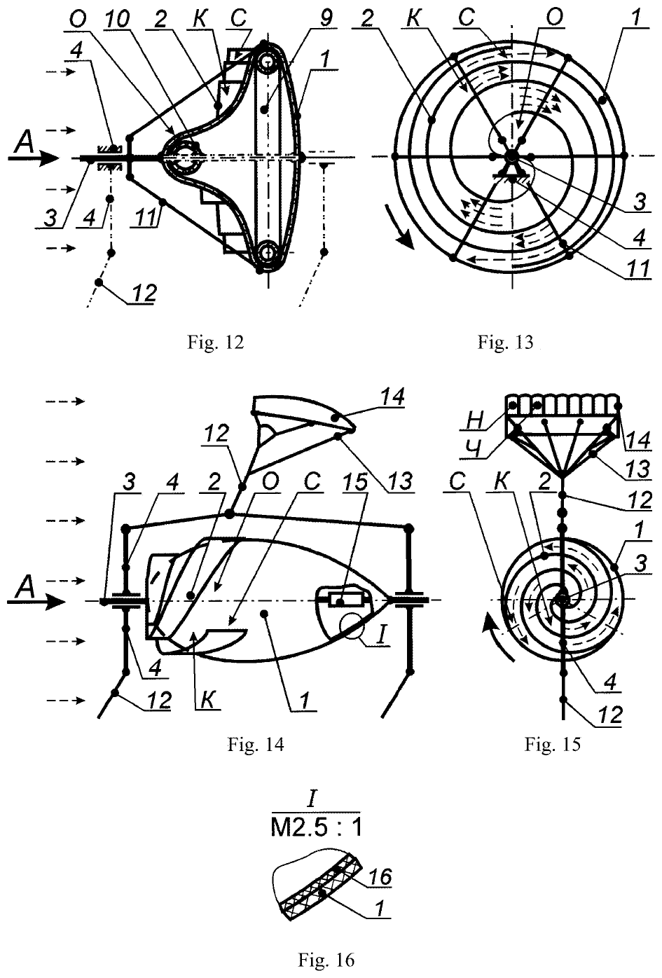

The claimed turbine (FIG. 1-33) contains the rotor 1 on which the guide apparatus is located with inlets for working fluid (liquid, gas) in the form of adjacent ducts K that are open over the total length or at least its significant part, spiraling each other into helices or similar shapes, with the nozzles C located along or close to a tangent to the circle of their rotation. The ducts K are located on the axial cowl O of the rotor 1 with the second order surface of revolution such as conical surface (FIG. 1), or ellipsoid surface (FIG. 5), or convex-concave surface of pseudosphere type with a cone (FIG. 3), or quasipseudosphere (FIG. 12), or part of such a surface, or combination of such parts.

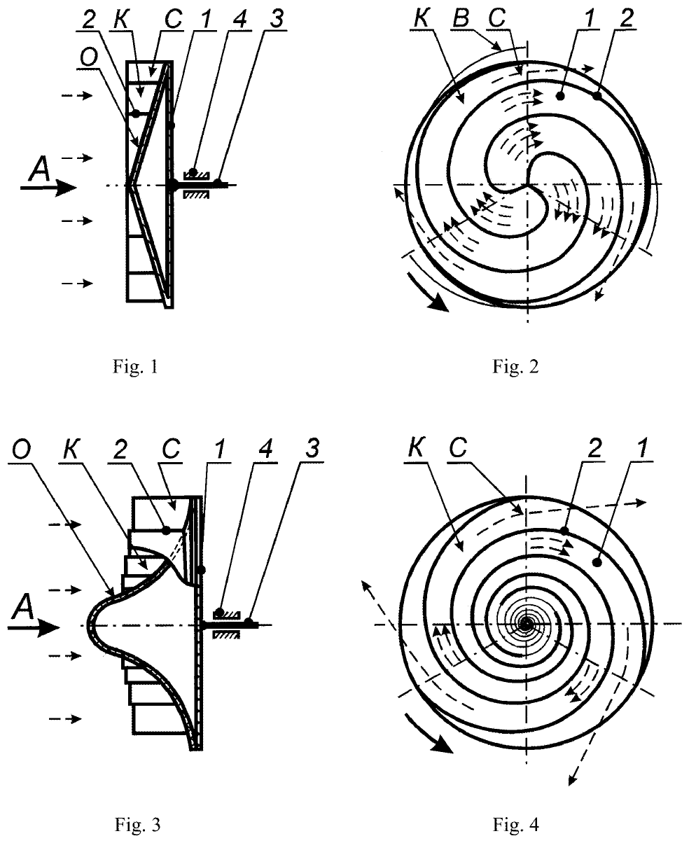

The ducts K of the guide apparatus can be placed in the form of helices with smooth function such as a logarithmic spiral (FIG. 4) with increasing pitch, an Archimedes spiral (FIG. 20) with constant pitch, a Fermat spiral (FIG. 2) with pitch decreasing on a projection on a plane, or a loxodromic curve (FIG. 6) as well as spirals with quasismooth function, along the paths gradually closing to the nozzle angles.

The ducts of the guide apparatus can be formed on the axial cowl with ribbons or ribbon-like elements running parallel to the axis of rotation. These ribbons can have such elasticity and are connected in the nozzle area to the surface of revolution at such an arc size that, should the specified angular velocity of the turbine be exceeded, the ribbons can be slightly straightened under the influence of centrifugal forces to change the nozzle cross-section.

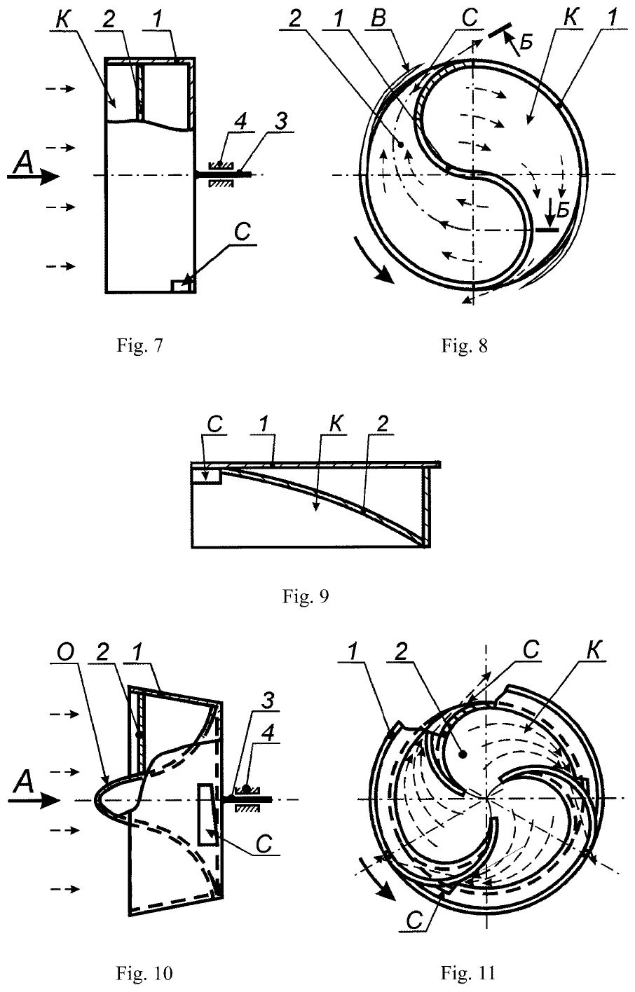

The ducts of the guide apparatus can be formed with ribbons of ribbon-like elements such as chutes in the shape of helicoidal surfaces that can be bordered with an axial cowl and a shell ring (FIG. 10) or only with a shell ring (FIG. 7). The helicoidal surfaces can be designed in the form of contours of Yin-Yang Monad in a projection on a plane (FIG. 8), three-way helicoidal surfaces—in the form of quasicontours of inner contours of Yin-Yang Monad in a projection on a plane (FIG. 10).

An axial cowl can be inflatable (FIG. 12) and in the form of the tethered aerostat, mostly drop-like and pseudospheroid with pitch in a pole. The devices heating buoyant gas are located inside the aerostat.

The turbine can be designed with a dome in the form of a round parachute with shrouds (FIG. 19) connected to the shaft, in particular telescopic one, as well as to the additional shrouds fixed to the dome in a zone of the nozzles circle and are wrapped with flexible material as an axial cowl. The axial cowl can be designed as a top part of the dome turned out inside, towards the nozzles. It can be closed and inflatable.

In this option, the dome, at least before the intersection with the axial cowl, can be multi-walled, at least two-walled, and is multi-ducted with inlets in its face part and bypass holes in its rear part, made with such parameters that ensure maintaining the specified dome shape with velocity pressure of working fluid at minimal operating speed. Moreover, the ducts can be closed and inflatable.

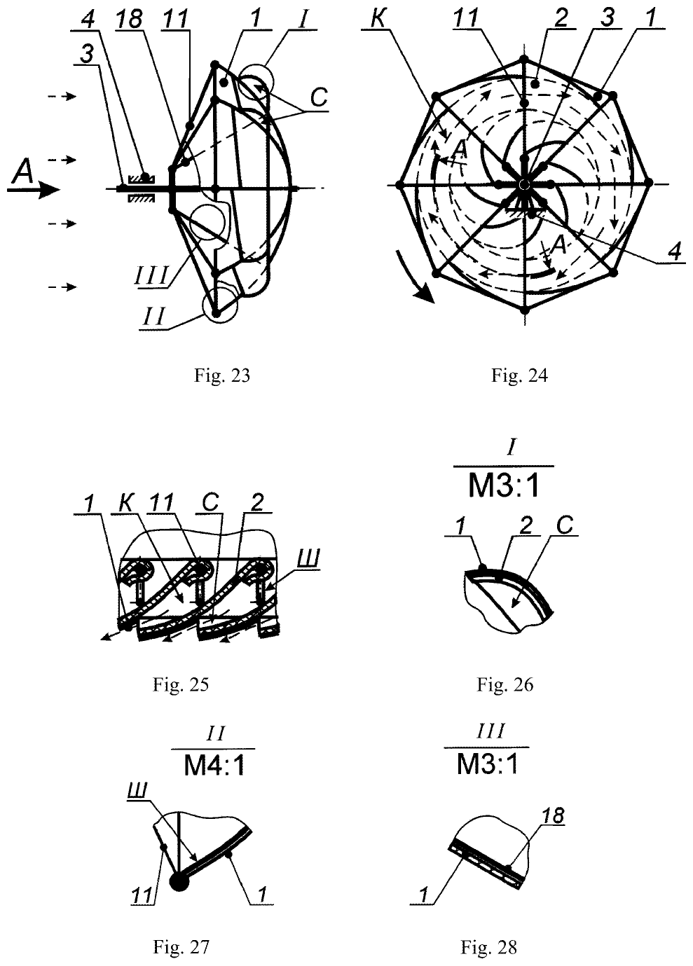

The dome can be designed in the form of an umbrella with a shaft, in particular a telescopic one (FIG. 23), with guy lines wrapped with flexible material and spokes connected to the shaft with shrouds on the periphery.

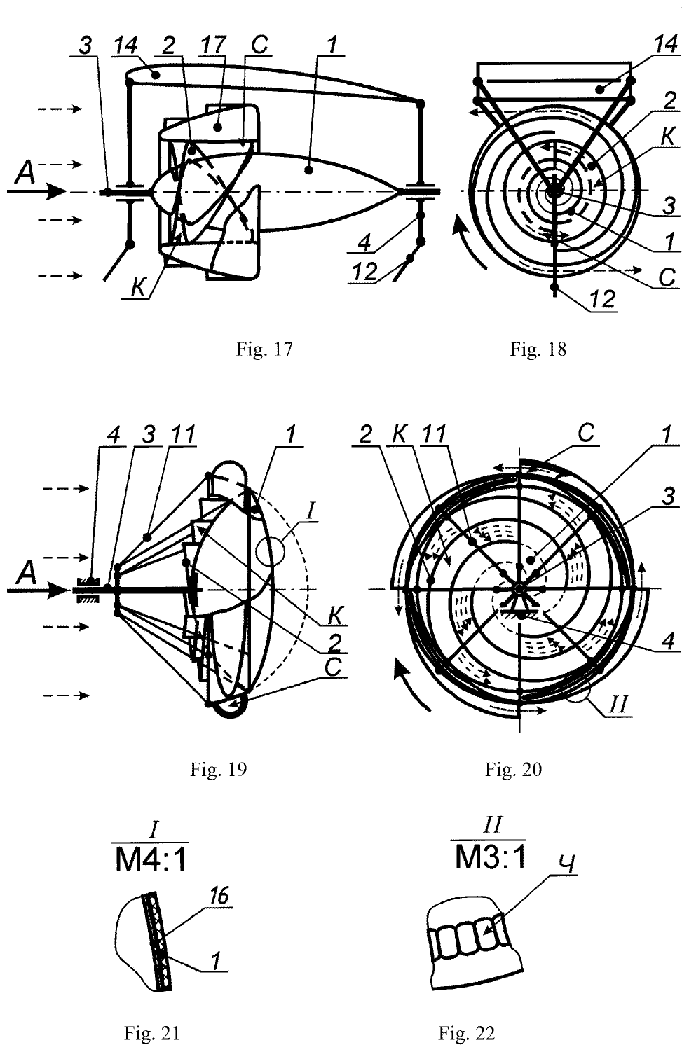

The axial cowl can be designed in the form of a tethered aerostat penetrating the dome. The aerostat can be connected to a kite (FIG. 17), in particular a kite in the form of a paraplane with a multi-ducted dome. The dome ducts, at least part of them, can be closed and inflatable (FIG. 14) or can have the form of a plane wing profile (FIG. 17). Inside the inflatable elements, there are inflatable balls of appropriate form made of elastic gas-barrier material that can be inflated to fill the cavities of the inflated elements with buoyant gas, density of which is less than density of air.

The duct inlets on the axial cowl (FIG. 3, 5, 10, 12, 17) can be located slightly lower its pole, the ducts helices being slightly cut inside circle-wise.

The turbine has such a number of nozzles and such parameters that at the rated speed of working fluid the total capacity of the nozzles approaches that of the working fluid inlets.

The outside turbine surfaces can be coated, at least partially, with photovoltaic elements, particularly thin-film ones.

The drawings contain several examples of the turbine design.

The wind turbine (FIG. 1, 2) contains the guide apparatus designed as the rotor 1 on the conical axial cowl O of which there are the ducts K narrowing in the form of a three-way Fermat spiral. The ducts K are formed with the ribbons 2 running parallel to the axis of the rotor 1 rotation. On the periphery of the ducts, there are the nozzles C located close to a tangent to their rotation circle. The shaft 3 of the wind turbine is installed on the stand 4. On the periphery, the ribbons 2 made of resilient material, are not fixed to the rotor 1 in the 60° position.

The operating principle of the turbine is explained below.

Flow of working fluid (wind) strikes the operating (swept) surface of the wind turbine, moves inside the open helical ducts K, compresses, accelerates under influence of centrifugal and other forces, while additional masses are joining during ejection process and move towards the nozzles C. In rated mode, layers of working fluid (air) move through the ducts along the corresponding immutable plane running through the point where air layer contacts the turbine and axis of its rotation. The jet reaction force from the nozzles C creates torque on the shaft 3 of the rotor 1. In case of exceeding the rated angular speed, the parts of helical ribbons 2 that are not fixed on the periphery are straighten (pos. B on FIG. 2) increasing the nozzles C flow section to decrease the jet speed and to recover the rated angular speed of the wind turbine.

The hydro turbine (FIG. 3, 4) contains the guide apparatus in the form of a rotor 1 on an axial cowl O of which there are the ducts K expanding in the form of a three-way logarithmic spiral. The ducts K formed with ribbons 2 are parallel to the axis of rotation of the rotor 1 inside the axial cowl O designed in the form of pseudosphere with a cone in its pole. On the periphery of the ducts, there are the nozzles C located close to a tangent to their rotation circle. The shaft 3 of the hydro turbine is installed on the stand 4.

The hydro turbine works like the wind turbine described above (FIG. 1, 2).

The hydro turbine (FIG. 5, 6) contains the guide apparatus formed with the chute-like ribbons 2 located on the oblate ellipsoid rotor 1 as two-way loxodromic curves. The shafts 3 of the turbine are located on the stands 4 connected with the cables 5 to the buoy 6 as well as to the anchor 8 with the chains 7.

The hydro turbine works like the hydro turbine described above (FIG. 3, 4).

The wind turbine (FIG. 7-9) contains the rotor designed as the guide apparatus with its ducts formed with helical ribbons 2 as a two-way helicoidal surface bordered with the shell ring and membranes having the contours of Yin-Yang Monad. The shaft 3 of the turbine is installed on the stand 4. The shell ring (outer contour of Yin-Yang Monad) is made of resilient material and is not fixed to the bottom of the nozzle at the 30° position.

### OPERATION OF THE INVENTION

The operating principle of the turbine is explained below.

Flow of working fluid (wind) strikes the operating surface of the swept wind turbine (the open ducts K), compresses, accelerates under influence of centrifugal and other forces, and moves towards the nozzles C. Torque is created partly because the working fluid changes its direction and partly thanks to jet forces of the nozzles C.

The hydro turbine (FIG. 10, 11) contains the rotor 1 designed as the guide apparatus with its ducts formed with the helical ribbons 2 as a three-way helicoidal surface bordered with the shell ring and membranes having the contours of Yin-Yang Quasimonad (with three inner Yin-Yang elements) and the axial cowl O of the rotor 1. The axial cowl O is designed in the form of the surface of revolution of the circular arc (element) with the ellipsoidal cone. The shaft 3 of the hydro turbine is installed on the stand 4.

The hydro turbine works like the turbine described above (FIG. 7-9).

The wind turbine (FIG. 12, 13) contains the inflatable guide apparatus with the forming elements, the torus 9 and the ball 10 inside the rotor 1, on the axial cowl O of which the narrowing ducts K in the form of a Fermat spiral are located. The ducts K are made of the helicoidal ribbons 2 running parallel to the axis of rotation of the rotor 1. On the periphery of the ducts, there are the nozzles C located close to a tangent to their rotation circle. The shaft 3 of the turbine is installed on the stand 4. The periphery of the rotor 1, in the zone of the inflatable torus 9, is connected to the shaft 3 with the shrouds 11. The thin dash-and-dot line with two dots indicates the wind turbine version as the tethered aerostat with tethers 12 and with the control device of the aerostat (it is not shown on the drawings).

The wind turbine works like the wind turbine described above (FIG. 1, 2).

The wind turbine (FIG. 14-16) contains the guide apparatus in the form of the tethered aerostat as the rotor 1, in the axial cowl O of which there are the ducts K in the form of a three-way Archimedes spiral. The ducts K are formed with the helicoidal ribbons 2 running parallel to the axis of rotation of the rotor 1. On the periphery of the ducts K, in the zone of the maximum cross-section, there are the nozzles C located close to a tangent of their rotation circle. The shaft 3 of the turbine is installed on the stand 4 which is connected with the tethers 12 to the ground control unit of the aerostat (it is not shown on the drawings) and is connected with the bridles 13 to the paraplane-type kite 14 with the inflatable ducts H and the cup-like ducts Ch. Inside the aerostat, there are the heaters 15 and the inflatable ball 16 made of gas-barrier material.

The wind turbine works like the wind turbine described above (FIG. 1, 2). Moreover, in case of loss of the buoyant gas and, as a result, decreasing of the aerostat pressure, the heater 15 turns on to maintain the set aerostat pressure. If the wind speed changes, the kite 14 helps to stabilize the aerostat altitude although when wind speed increases, the force pressing the aerostat to the ground also increases but the force lifting the kite increases too.

The wind turbine (FIG. 17, 18) contains the guide apparatus in the form of the tethered aerostat as a rotor 1 on the axial cowl O of which there are the ducts K formed by a two-way helicoidal surface bordered with the shell ring 17. The shell ring 17 is made as a ring-shaped aerostat with a conical outer surface. The aerostat is used as an axial cowl O of the guide apparatus, the ducts K of which in the shape of a two-way Fermat spiral are formed with the ribbons running parallel to the axis of rotation. The shaft 3 of the turbine is installed on the stand 4 which is connected with the tethers 12 to the ground control unit of the aerostat (it is not shown on the drawings) and to the kite 14 that has an airplane wing profile.

The wind turbine works like the wind turbine described above (FIG. 1, 2).

The wind turbine (FIG. 19-22) is designed in the form of a round parachute with a top part of its dome turned out inside and closed from the rear side as an axial cowl. The axial cowl contains the inflatable ball 16 filled with helium. The wind turbine has the guide apparatus designed in the form of the ducts K on the axial cowl. The ducts are formed with the ribbons 2 parallel to the axis of rotation such as a two-way Archimedes spiral. Sides of the parachute are connected to the shaft 3 installed on the stand 4. In a zone of intersection between the dome and the axial cowl, there are the nozzles C. Also, the shrouds 11 are fixed in this zone. Before intersection with the axial cowl, the dome is two-walled and multi-ducted in the form of cups Ch, open in the front part and with bypass holes in the rear part.

The wind turbine works like the wind turbine described above (FIG. 1, 2).

The wind turbine (FIG. 23-28) contains the rotor 1 designed in the form of an umbrella, with guy lines 18 of the umbrella wrapped with flexible material and the spokes Sh of the umbrella connected to the shaft 3 with the shrouds 11 on the periphery. The ducts K having form of an eight-way helicoidal surface on the axial cowl are used as the guide apparatus. The ducts are formed with the ribbons 2 of the helix. The ribbons are fixed to the shrouds 11. On the periphery of the ducts K, there are the nozzles C located close to a tangent of their rotation circle. The shaft 3 of the turbine is installed on the stand 4.

The wind turbine works like the wind turbine described above (FIG. 1, 2).

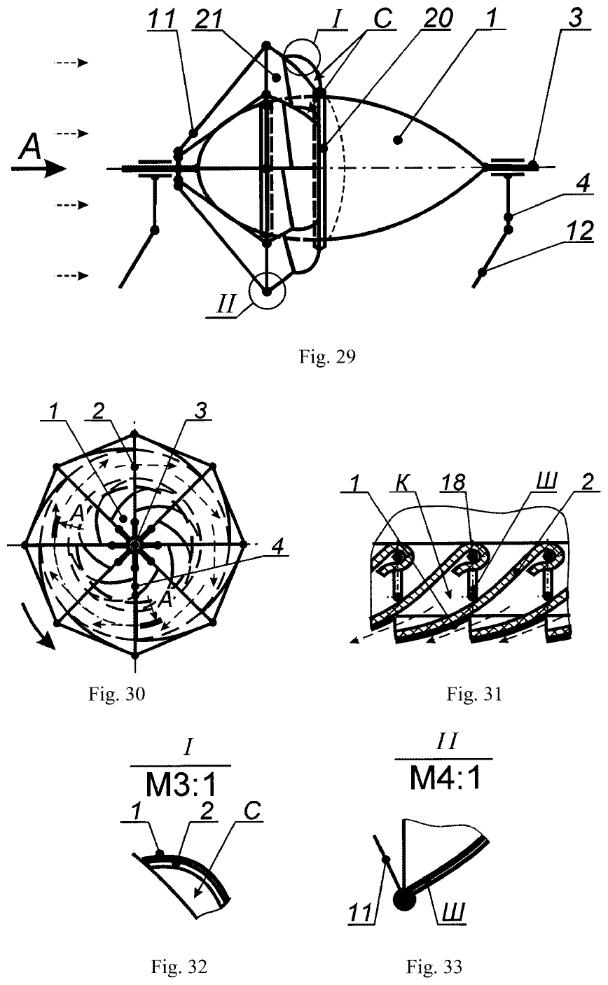

The wind turbine-umbrella on the tethered aerostat (FIG. 29-33) contains the rotor 1 designed in the form of an umbrella, the dome 21 of which is penetrated with the tethered aerostat. The guy lines 18 of the umbrella are wrapped in flexible material and fixed with the ring 20 to the tethered aerostat as an axial cowl, and the spokes Sh of the umbrella on the periphery are connected to the shaft 3 with the shrouds 11. As a guide apparatus, there are the ducts K in the form of an eight-way helicoidal surface on the axial cowl. The surface is formed with the ribbons 2 of the spiral which are fixed on the guy lines 18 and bordered with the umbrella dome 21. On the periphery of the ducts K, there are the nozzles C located close to a tangent of their rotation circle. The shaft 3 of the turbine is installed on the stand 4 which is connected with the tethers 12 to the ground control unit of the aerostat (it is not shown on the drawings).

The wind turbine works like the wind turbine described above (FIG. 1, 2).

The claimed method is to be embodied as follows.

Working fluid (liquid, gas) is distributed into several flows that are directed along the helical paths spiraling each other into the nozzles situated along a tangent to the circle of rotation thereof or close to a tangent. Continuous flow of working fluid is divided into adjacent flows that are open over their total length or at least over significant part of their length.

The flows can be directed along paths in the form of a spiral with smooth function such as an Archimedes spiral with constant pitch, a Fermat spiral with pitch decreasing in a projection on a plane, and loxodromic curves, as well as along paths in the form of spirals with quasismooth function, namely paths gradually closing to the nozzle angles.

An example. In the wind turbine (FIG. 1, 2), on the conical axial cowl O of the rotor 1, the parallel ribbons 2 of the spiral in the form of a three-way spiral forming the open ducts K. Air is directed through the ducts into the nozzles. During ejection process, additional wind masses join moving with acceleration thanks to centrifugal forces towards the periphery of the nozzle C. Tangential component of reactive force creates torque on the shaft 3.

What is claimed is:

1. A turbine containing the rotor (1) with a guide apparatus holding a working fluid inlet in a form of ducts (K) that spiral around each other in helices or similar way, with nozzles (C) situated along a tangent to a circle of rotation or close to a tangent, that differs in that the guide apparatus is made in the form of adjacent ducts (K) which are open along a whole length or at least a considerable length and are situated on second order surfaces of revolution, or on portions of such surfaces, or on combinations of these portions, in particular on convex-concave surfaces of a pseudosphere type with a cone in a pole of an axial cowl (O) of a rotor (1).

2. The turbine of claim 1 differs in that the ducts (K) of the guide apparatus have a form of smooth function spirals such as a logarithmic spiral with increasing pitch, an Archimedes spiral with constant pitch, a Fermat spiral with pitch reducing in a projection on a plane, or a loxodromic curve.

3. The turbine of claim 1 differs in that the ducts (K) of the guide apparatus have a form of spirals with quasismooth function and arranged along paths gradually approaching nozzle (C) angles or close to it.

4. The turbine of claim 1 differs in that the ducts (K) of the guide apparatus are made on the axial cowl (O) with ribbons (2) or ribbon-like elements parallel to an axis of rotation.

5. The turbine of claim 4 differs in that the ribbons (2) have such elasticity and are connected in the nozzle area (C) with the surface of revolution at such an arc size that, should a specified angular velocity of the turbine be exceeded, the ribbons (2) can be slightly straightened under an influence of centrifugal forces to change a nozzle (C) cross-section.

6. The turbine of claim 1 differs in that the ducts (K) of the guide apparatus are formed with ribbons (2) or ribbon-like elements such as chutes, in a form of helicoidal surface.

7.-9. (canceled)

10. The turbine of claim 1 differs in that the axial cowl (O) is inflatable.

11. The turbine of claim 1 differs in that the axial cowl (O) is designed in a form of a tethered aerostat, mostly drop-shaped and quasispheroidal with a cone in a pole, and the nozzles (C) are located in a diameter zone of a maximum cross-section.

12. The turbine of claim 11 differs in that the tethered aerostat is made with an inflatable shell ring (17) with the ducts (K) inside.

13. The turbine of claim 11 differs in that the tethered aerostat is made with an inflatable shell ring with the ducts (K) both inside and outside.

14. The turbine in of claim 1 differs in that it is designed with a dome in a form of a round parachute with its shrouds (11) connected to a shaft (3), in particular telescopic one, as well as to additional shrouds fixed to the dome in a zone of the nozzles (C) circle and are wrapped with flexible material as the axial cowl (O).

15. The turbine of claim 14 differs in that the axial cowl (O) is designed as a top part of the dome turned out inside, towards the nozzles (C).

16. The turbine of claim 15 differs in that the turned out part of the dome is closed and inflatable.

17. The turbine of claim 14 differs in that the dome, at least before its intersection with the axial cowl, is multi-walled, at least two-walled, and is multi-ducted with inlets in its face part and with bypass holes in its rear part, designed with such parameters that ensure maintaining a specified dome shape with velocity pressure of working fluid at minimal operating speed.

18. The turbine of claim 1 differs in that it is designed with the dome (21) in a form of an umbrella, in particular with a telescopic shaft and guy lines (18) wrapped with flexible material as the axial cowl (O) and spokes (Sh) are connected to the shaft (3) with the shrouds (11) on a periphery.

19. The turbine of claim 18 differs in that the axial cowl (O) is designed in a form of a tethered aerostat penetrating the dome (21).

20. (canceled)

21. The turbine of claim 11 differs in that the tethered aerostat is connected to a kite (14) which is in particular has a structure of a paraplane with a multi-ducted dome or with an airplane wing profile.

22. The turbine of claim 21 differs in that the dome ducts (H), at least part of them, are closed and inflatable.

23.-28. (canceled)

29. A method for turbine rotation, according to which a working fluid is divided into several flows and is directed, along helical or similar paths spiraling each other, into nozzles located along a tangent to a circle of their rotation or close to it, according the invention, differs in that the continuous flow of working fluid is divided into adjacent ducts which are open along a whole length or at least a considerable part.

30.-31. (canceled)
